(19) United States
(12) Patent Application Publication
(10) Pub. No.: US 2015/0042141 A1
(43) Pub. Date: Feb. 12, 2015

(54) RECLINE BOAT SEAT HINGE

(71) Applicant: E&S Concepts LLC, Defiance, OH (US)

(72) Inventors: Brad Sines, Defiance, OH (US); Tyson Ellert, Defiance, OH (US)

(21) Appl. No.: 14/457,228

(22) Filed: Aug. 12, 2014

Related U.S. Application Data
(60) Provisional application No. 61/864,841, filed on Aug. 12, 2013.

(51) Int. Cl. B63B 29/04; B60N 2/20; B60N 2/22

(52) U.S. Cl. CPC B63B 29/04; B60N 2/22; B60N 2/20; B63B 2029/043
USPC 297/354.12

(57) ABSTRACT

The present invention involves a recline boat seat having a dual position hinge to allow the user to adjust the seat back position manually.

### CROSS-REFERENCE TO RELATED APPLICATIONS

The present application claims priority under 35 U.S.C. §119 of U.S. Provisional Patent Application Ser. No. 61/864,841, filed Aug. 12, 2013, the disclosures of which are incorporated by reference herein.

### BACKGROUND OF THE INVENTION

1. Field of the Invention

The field of the invention is that of boat seats, particularly those boat seats attached to watercraft that are exposed to the elements.

2. Description of the Related Art

Seats may be used in many different environments. One such environment is on boats or other watercraft. Boat seats allow a user of a boat or other Watercraft to be seated in a comfortable position to increase the user's enjoyment of the boating experience. For example, the driver of a boat is often positioned on a boat seat mounted on a pole next to the steering apparatus of the boat. Other posts may be located on the boat floor and support boat seats for passengers, for example to provide several positions for riders to sit and watch the surroundings or fish. It is often desirable for a boat seat to possess the capability for the seat back to be lowered into a stowed position by a user when the boat seat is not in use to position it out of the way, and to be raised to an extended position when the user wishes to sit on the boat seat. An example of such a boat seat is disclosed in U.S. Pat. No. 8,123,298 to Chen, the disclosures of which are explicitly incorporated by reference.

Other boat seats are mounted on a frame or box system rather than poles. One example of such a system is disclosed in U.S. Pat. No. 4,544,199 to Wrigley, the disclosures of which are incorporated by reference. In the Wrigley system, the seats may be put into several different states of reclining, so that the riders of the boat may adjust the reclining angle. A pair of laterally opposed tracks are respectively affixed to the inner faces of sidewalls, with each track section being of generally C-shaped cross section. A channel is formed in each sidewall and extends longitudinally of the associated track section. The channel has a plurality of upwardly extending spaced semi-circular recesses which are engaged by a tubular locking bar to keep the seat back in a particular angular orientation.

### SUMMARY OF THE INVENTION

The present invention involves a recline boat seat having a dual position hinge to allow the user to adjust the seat back position manually.

### BRIEF DESCRIPTION OF THE DRAWINGS

The above mentioned and other features and objects of this invention, and the manner of attaining them, will become more apparent and the invention itself will be better understood by reference to the following description of an embodiment of the invention taken in conjunction with the accompanying drawings, wherein:

FIG. 1 is a plan view of one embodiment of a base plate in a flat stamp configuration for a hinge constructed according to the present invention.

FIG. 2 is a plan view of one embodiment of a seat back plate in a flat stamp configuration for a hinge constructed according to the present invention.

FIG. 3A illustrates a left side view of an embodiment of a boat seat in a folded position.

FIG. 3B illustrates a front view of the boat seat of FIG. 3A in the folded position.

FIG. 3C illustrates a rear view of the boat seat of FIG. 3A in the folded position.

FIG. 3D illustrates a bottom view of the boat seat of FIG. 3A in the folded position.

FIG. 4A illustrates a left side view of an embodiment of the left hinge assembly in a folded position.

FIG. 4B illustrates a right side view of the left hinge assembly of FIG. 4A in the folded position

FIG. 4C illustrates a bottom view of the left hinge assembly of FIG. 4A in the folded position.

FIG. 4D illustrates a top view of the left hinge assembly of FIG. 4A.

FIG. 4E illustrates a front side view of the left hinge assembly of FIG. 4A in the folded position.

FIG. 4F illustrates a back side view of the left hinge assembly of FIG. 4A in the folded position.

FIG. 5 illustrates a left side view of an embodiment of the left hinge assembly of FIGS. 4A-4F in a first extended position;

FIG. 6A illustrates a left side view of an embodiment of the boat seat in which the left hinge assembly 110 and the right hinge assembly 115 are in a first extended position.

FIG. 6B illustrates a front view of the boat seat 100 of FIG. 6A in the first extended position.

FIG. 6C illustrates a rear view of the boat seat 100 of FIG. 6A in the first extended position.

FIG. 7 illustrates a left side view of an embodiment of the left hinge assembly of FIGS. 4A-4F in a second extended position.

FIG. 8A illustrates a left side view of an embodiment of the boat seat in which the left hinge assembly 110 and the right hinge assembly 115 are in the second extended position.

FIG. 8B illustrates a front view of the boat seat 100 of FIG. 8A in the second extended position.

FIG. 8C illustrates a rear view of the boat seat 100 of FIG. 8A in the second extended position.

Corresponding reference characters indicate corresponding parts throughout the several views. Although the drawings represent embodiments of the present invention, the drawings are not necessarily to scale and certain features may be exaggerated in order to better illustrate and explain the present invention. Although specific measurements and angles may appear on the drawings, such measurements merely exemplify one of multiple embodiments of the invention. The exemplification set out herein illustrates an embodiment of the invention, in one form, and such exemplifications are not to be construed as limiting the scope of the invention in any manner.

### DESCRIPTION OF EMBODIMENTS OF THE PRESENT INVENTION

The embodiments disclosed below is/are not intended to be exhaustive or limit the invention to the precise form disclosed in the following detailed description. Rather, the embodiment is chosen and described so that others skilled in the art may utilize its teachings.

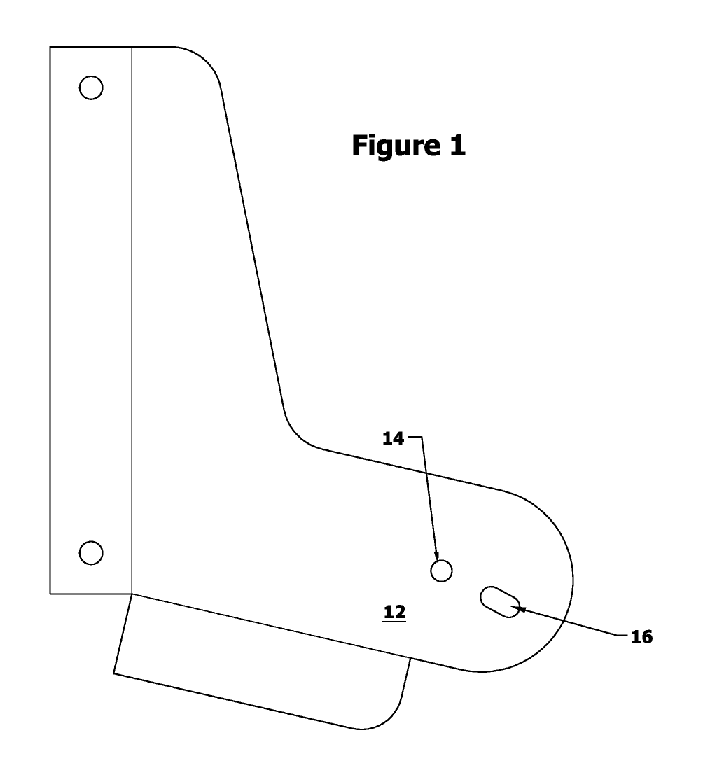

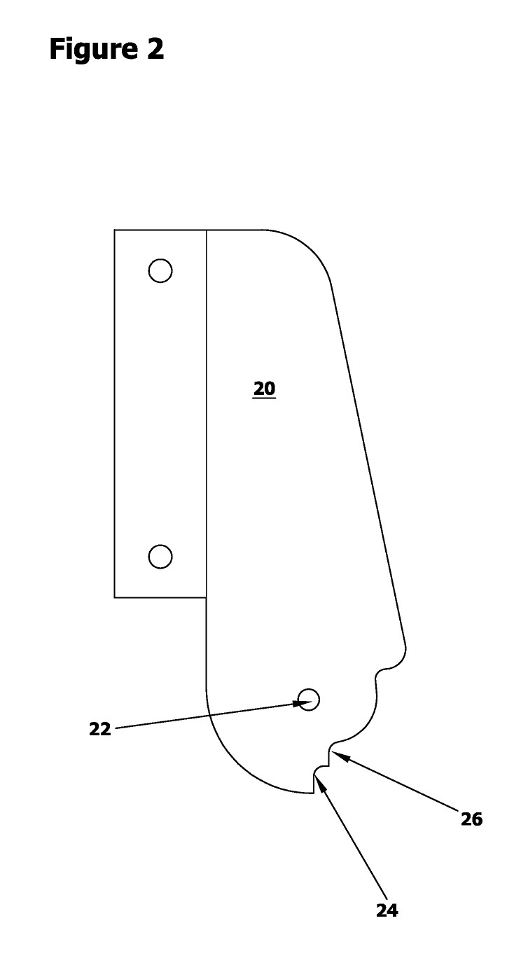

FIGS. 1 and 2 show base plate having seat support portion 10 and hinge extension 12 in a flat stamp configuration, with the latter figures showing analogs wherein portions of the flat stamp are bent into a final form. Support portion 10 and hinge extension 12, in this exemplary embodiment, are part of a unitary generally flat piece of metal which is subsequently bent into a final configuration. Alternatively, base plate support portion 10 and/or hinge extension 12 may be made of a high density plastic material capable of supporting the weight imposed on a seat, for example by injection molding or by 3D printing.

Support portion 10, in this embodiment, has a flange (not shown in FIG. 1) adapted to connect and support a seat cushion (not shown in FIG. 1). Hinge extension 12 includes stop pin 14, which extends upwardly from the plane of the base plate. Hinge extension also has a through portion defining pivot axle hole 16, which is shaped to receive a pin or axle (not shown in FIG. 1) of the seat back portion. In the exemplary embodiment, pivot axle hole 16 defines a generally linear hole wherein the line so defined generally projects through the center of stop pin 14, although pivot axle hole 16 may be otherwise oriented and still provide the multiple reclining angles disclosed in the present disclosure. The thickness of pivot axle hole may be exactly the thickness of pivot axle 22 of FIG. 2, or alternatively may be slightly or significantly larger than pivot axle 22. Design configurations such as the degree of freedom of movement of the upper seat cushion (not shown in FIG. 1 or 2) and the amount of stabilization provided by other parts of the seat assembly which are optionally used with a recline boat seat (also not shown on any of the Figures).

Back portion 20, in this embodiment, has a flange extending generally perpendicularly extending flange (not shown in FIG. 2) adapted to be engaged with a back cushion (not shown in FIG. 2). At a lower end, pivot axle 22 is configured and arranged to extend through pivot axle hole 16, to allow for movement of pivot axle 22. In the illustrated embodiment axle hole 16 is generally linear and elongated, configured to accept movement of pivot axle 22. In alternative embodiments, pivot axle hole 16 may be arched or angled to provide a desired range of movement. The lower portion of back portion 20 has a generally arched surface with stop shoulders 24, 26, and optionally stop shoulder 28 (stop shoulder 28 may be omitted as in a particular combination with a seat cushion not shown may prevent pivot pin 14 from ever abutting stop shoulder 28). Alternatively, the pivot axle may be formed on hinge extension 12 and the slot formed around the area of pivot axle 22, a reversal of parts that is within the teaching of the present disclosure and would operate in a similar manner to the embodiments disclosed herein.

When joined together, hinge extension portion 12 and the lower portion of back portion 20 are configured and arranged to provide a multiple location hinge. With pivot axle 22 in one position within pivot axle hole 16, back portion 20 may be moved from a sitting position wherein stop pin 14 abuts stop shoulder 24 to a collapsed position where stop pin 14 abuts stop shoulder 28. Further, the operator of the seat may pull back portion 20 (generally by grabbing the seat cushion) and reorient pivot axle 22 so that stop pin 14 abuts stop shoulder 24. The angle at which back portion 20 reclines relative to seat support portion 10 depends on the distance of pivot axle hole 16 and stop pin 14 and other configuration factors of the possible angular positions of pivot axle hole 16. Optionally, a washer or other friction mitigating material may be located proximate pivot axle 22 and between back portion 20 and hinge extension portion 12 to facilitate the rotation of back portion 20 about pivot axle 22.

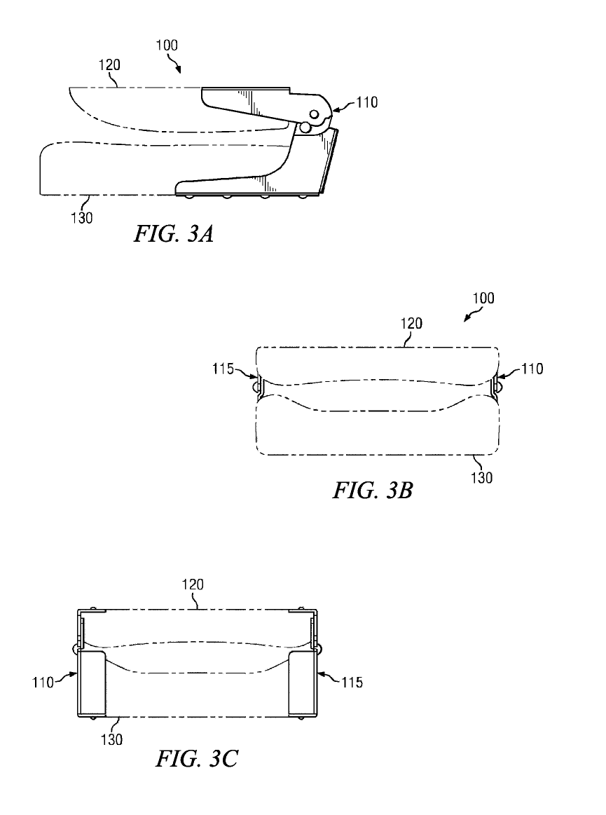

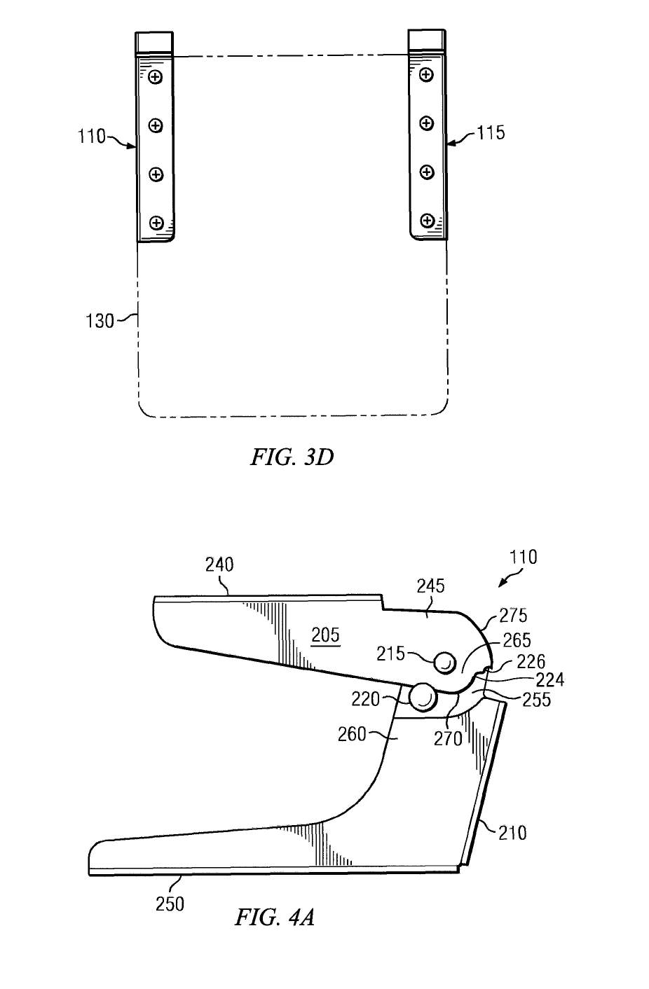

FIGS. 3-8 show the combination and operation of embodiments of the hinge extension portion/back portion combination. Referring now to FIG. 3A, a left side view of an embodiment of a boat seat 100 in a folded position is illustrated. Boat seat 100 includes a seat back 120 and seat bottom 130 coupled to a left hinge assembly 110. FIG. 3B illustrates a front view of boat seat 100 of FIG. 3A in the folded position. As illustrated in FIG. 3B, boat seat 100 further includes right hinge assembly 115 coupled to seat back 120 and seat bottom 130. FIG. 3C illustrates a rear view of boat seat 100 of FIG. 3A in the folded position. FIG. 3D illustrates a bottom view of boat seat 100 of FIG. 3A in the folded position. The folded position of boat seat 100 allows seat back 120 to be lowered while boat seat 100 is not in use.

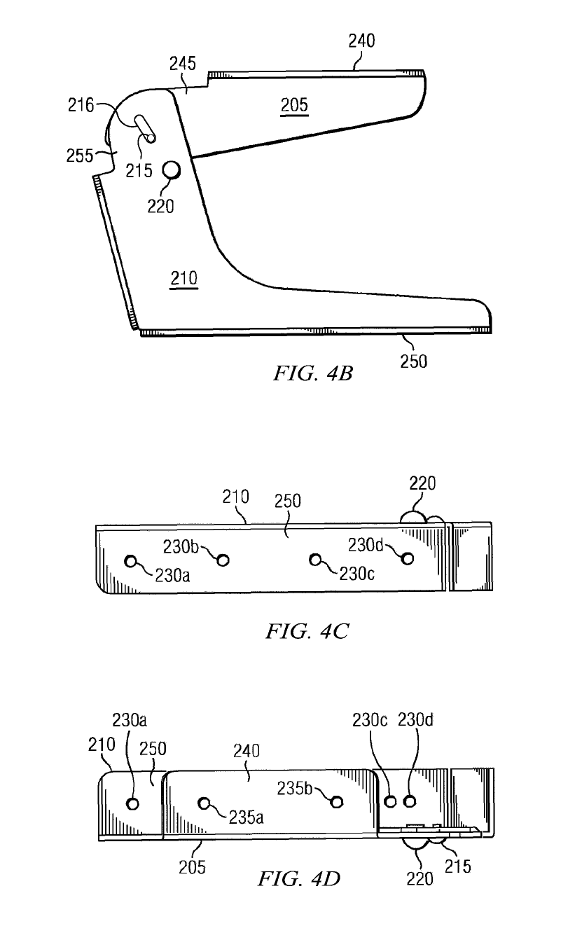

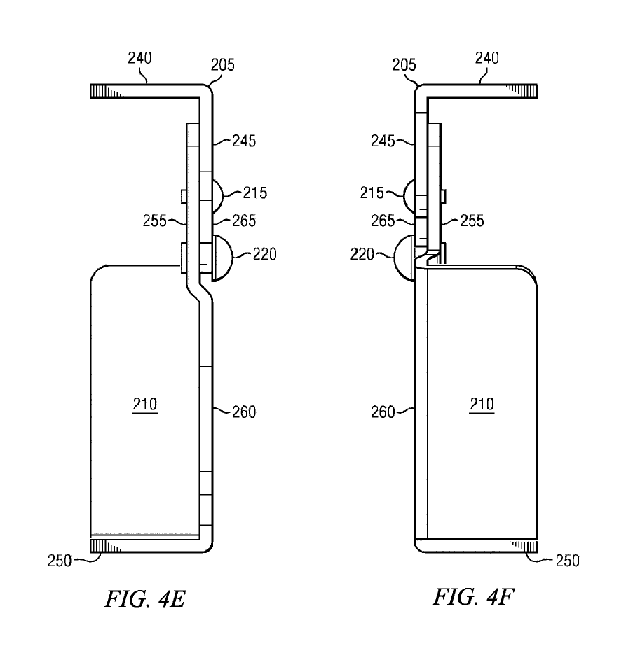

An embodiment of left hinge assembly 110 is described in more detail with respect to FIGS. 4A-4F. In various embodiments, right hinge assembly 115 is constructed in a mirror image of left hinge assembly 110 and positioned on the opposite sides of seat back 120 and seat bottom 130 as left hinge assembly 110. It should be understood that a bottom surface of seat bottom 130 may be configured to be attached to a support such as a supporting post or supporting frame to allow mounting of boat seat 100 to a surface such as a boat or other watercraft.

FIG. 4A illustrates a left side view of an embodiment of left hinge assembly 110 in a folded position. Left hinge assembly 110 includes seat back support 205 hingedly coupled to seat bottom support 210 by hinge pivot 215. Seat back support 205 includes seat back mounting portion 240 and seat back hinge portion 245 distally located at an end of seat back mounting portion 240. In at least one embodiment, the seat back mounting portion may be comprised of a flat plate with upper and lower parallel surfaces. Seat back mounting portion 240 is configured to allow seat back support 205 to be attached to seat back 120. Seat bottom support 210 includes seat bottom mounting portion 250 and seat bottom hinge portion 255 distally located from seat bottom mounting portion 250.

Seat bottom mounting portion 250 is configured to allow seat bottom support 210 to be attached to seat bottom 130. Seat back hinge portion 245 of seat back support 205 is coupled to seat bottom hinge portion 255 of seat bottom support 210 via hinge pivot 215. In various embodiments, hinge pivot 215 passes through slot 216 of seat back hinge portion 245 of seat back support 205 and a flat surface on seat bottom hinge portion 255 of seat bottom support 210. In at least one embodiment, hinge pivot 215 is disposed in seat back hinge portion 245 and distally positioned from seat back mounting portion 240. Hinge pivot 215 allows seat back support 205 to rotate about hinge pivot 215 to allow seat back 120 to be positioned by a user from a folded position to one of two extended positions. In a particular embodiment, portion of seat back hinge portion 245 is positioned adjacent to a portion of seat bottom hinge portion 255. In at least one embodiment, the distal end of seat bottom hinge portion 255 has a flat surface which is recessed with respect to first surface 260 of seat bottom support 210. In at least one embodiment, the recessing of seat bottom hinge portion 255 with respect to first surface 260 allows first surface 260 of seat bottom support 210 to lie substantially in the same plane as second surface 265 of seat back hinge portion 245 that comprises one of the surfaces of the flat plate of seat back mounting portion 245. In a particular embodiment, seat back hinge portion 265 has first curved edge 270 and a second curved edge 275 and stop notches 224 and 226 is integrally formed between first curved edge 270 and second curved edge 275 to provide the multiple seat back positions, in this embodiment two seat back positions.

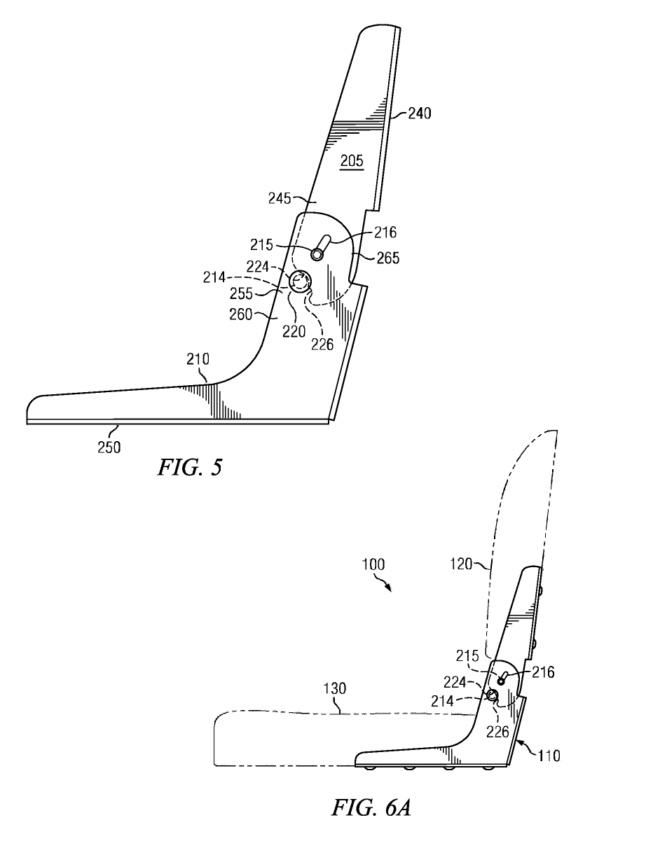

Left hinge assembly 110 further includes stop pin 220 affixed to seat bottom hinge portion 255 of seat bottom support 210 proximate to seat back hinge portion 245 of seat back support 205. Seat back support 205 further includes stop notches 224 and 226 integrally formed in the outer surface at the distal end the seat back hinge portion 245 of seat back support 205. In at least one embodiment, stop notches 224 and 226 are formed of a substantially curved shape. In still other embodiments, stop notches 224 and 226 may be formed of a substantially square, substantially rectangular shape, or any other shape. As further described with respect to FIGS. 5, 6A-6C, 7 and 8A-8C, stop pin 220 is configured to engage either stop notch 224 or 226 upon rotation of left hinge assembly 110 to one of the extended positions to prevent further rotation of seat back support 205 beyond the selected extended position.

FIG. 4B illustrates a right side view of left hinge assembly 110 of FIG. 4A in the folded position. FIG. 4C illustrates a bottom view of left hinge assembly 110 of FIG. 4A in the folded position. As illustrated in FIG. 4C, seat bottom mounting portion 250 of seat bottom support 210 further includes one or more seat bottom attachment holes 230a-230d to facilitate attachment of seat bottom mounting portion 250 of seat bottom support 210 to seat bottom 130 using one or more fasteners, such as screws or bolts. FIG. 4D illustrates a top view of left hinge assembly 110 of FIG. 4A. As illustrated in FIG. 4D, seat back mounting portion 240 of seat back support 205 further includes one or more seat back attachment holes 235a-235b to facilitate attachment of seat back mounting portion 240 of seat back support 205 to seat back 120 using one or more fasteners.

FIG. 4E illustrates a front side view of left hinge assembly 110 of FIG. 4A in the folded position. FIG. 4F illustrates a back side view of left hinge assembly 110 of FIG. 4A in the folded position. As illustrated more clearly in FIGS. 4E and 4F, in at least one embodiment, seat back mounting portion 240 of seat back support 205 is disposed substantially perpendicular to a remaining portion of seat back support 205 to facilitate attachment of seat back mounting portion 240 to a back surface of seat back 120. In the embodiments of FIGS. 4E and 4F, hinge pivot 215 and stop pin 220 have a configuration as bolts or rivets, while in alternative embodiments such items may be configured in the form of shoulder bolts or other equivalent mechanisms. In still other embodiments, seat back mounting portion 240 may be disposed at any angle in relation to the remaining portion of the seat back support 205. Further, in at least one embodiment, seat bottom mounting portion 250 is disposed substantially perpendicular to a remaining portion of seat bottom support 210 to facilitate attachment of seat bottom mounting portion 250 to a bottom surface of seat bottom 130. In still other embodiments, seat bottom mounting portion 250 may be disposed at any angle in relation to the remaining portion of seat bottom support 210.

FIG. 5 illustrates a left side view of an embodiment of left hinge assembly 110 of FIGS. 4A-4F in a first extended position. In the embodiment illustrated in FIG. 5, seat back support 205 is positioned in the first extended position such that stop notch 224 in seat back hinge portion 245 of seat back support 205 is engaged with stop pin 220 affixed to seat bottom hinge portion 255 of seat bottom support 210. When seat back support 205 is initially positioned back from to folded position to the first extended position, stop notch 224 is engaged with stop pin 220 and pivot pin 215 is located in the lower portion of slot 216.

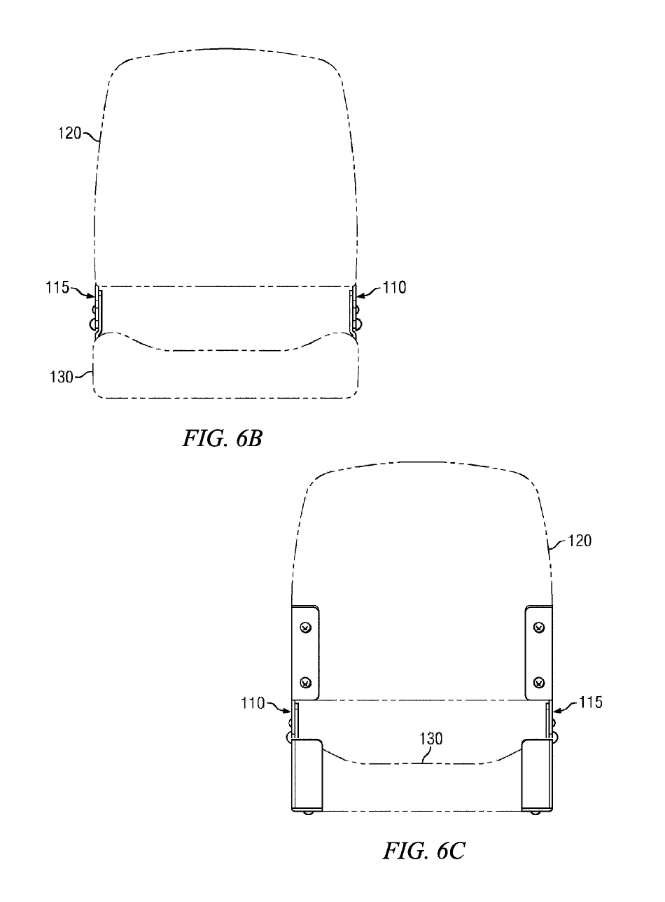

Referring now to FIG. 6A, a left side view of an embodiment of boat seat 100 in which left hinge assembly 110 and right hinge assembly 115 (not specifically shown in FIG. 6A) are in a first extended position is illustrated. FIG. 6B illustrates a front view of boat seat 100 of FIG. 6A in the first extended position. FIG. 6C illustrates a rear view of boat seat 100 of FIG. 6A in the first extended position. As illustrated in FIGS. 6B-6C, both left hinge assembly 110 and right hinge assembly 115 are positioned in the first extended position resulting in seat back 120 being in the first extended position. The first extended position of seat back 120 of boat seat 100 allows seating of a user on boat seat bottom 130 and support of the back of the user by seat back 120, for example in one embodiment supporting seat back 120 in an approximately perpendicular orientation. Stop pin 220 prevents seat back 120 from being rotated past the first extended position, unless seat back 120 is lifted by the user so that pivot 215 extends to the highest portion of slot 216 which enables the second extended position. In at least one embodiment, stop pin 220 provides an advantage of preventing or reducing injury to a user that may result due to seat back 120 rotating past the first extended position.

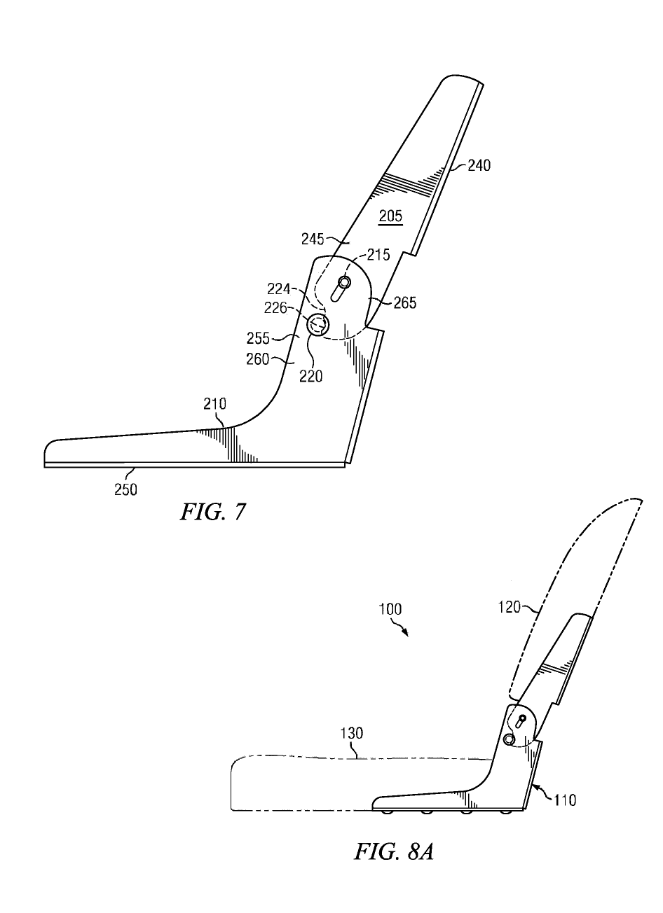

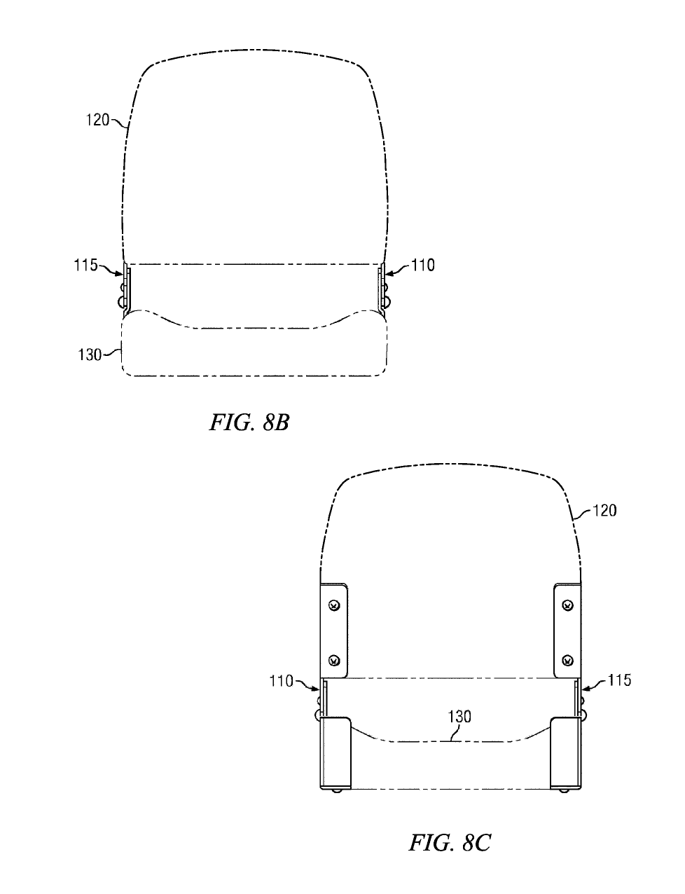

FIGS. 7 and 8A-8C are similar to the views of FIGS. 5 and 6A-6C except that in these views seat back 120 is in the second extended position, for example without limitation a tilted back position between 10° and 25°. To achieve the second extended position, the user lifts up seat back 120 so that pivot 215 is positioned higher in slot 216 allowing for back support 205 to extend backward until stop notch 226 abuts pin 220. In the depicted embodiment, seat back 120 is prevented from further reclining. Alternatively, slot 216 may have a longer extension and further stop notches may be provided to create several recline positions. The angles of reclining are determined by the relative size and shape of slot 216, notches 224 and 226, and pivot pin 215, and may be varied to accommodate various angles and uses. The examples in the foregoing description and accompanying drawings are illustrative of one embodiment of the invention and is not a full exposition of all possible variations and adaptations.

Although the embodiment of left hinge assembly 110 has been described as a component of boat seat 100, it should be understood that in other embodiments hinge assembly 110 may be applied to any type of foldable seat having a seat back with a capability to be rotated into multiple extended positions. For example, left hinge assembly 110 may be used as a seat hinge for any portable folding seat such as those designed to be carried to sporting events or other outdoor activities.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A recline boat seat comprising:
a back portion;
a seat portion; and
a hinge connected to the back portion and the seat portion, the hinge comprising:
a seat bottom support portion having a flange connected to the seat portion, the seat bottom support portion including a pivot slot and a stop pin,
a seat back support portion having a flange connected to the back portion, the seat back support portion including a pivot pin and a notched portion, the pivot pin slideably engaging the pivot slot, the notched portion having a plurality of notches configured to engage the stop pin, the seat back support portion being structured and arranged to engage the seat bottom support portion in at least three positions, a first closed position wherein the notched portion is rotated out of engagement with the stop pin, a first recline position wherein a first one of the plurality of notches engages the stop pin, and a second recline position wherein a second one of the plurality of notches engages the stop pin.

2. The recline boat seat of claim 1 wherein the plurality of notches comprises two notches corresponding to the first and the second recline positions.

3. The recline boat seat of claim 1 wherein the seat bottom support portion is formed from a flat piece of metal and bent to form the flange.

4. The recline boat seat of claim 1 wherein the back support portion is formed from a flat piece of metal and bent to form the flange.

5. The recline boat seat of claim 1 wherein the slot is a linear elongated slot configured to allow linear movement of the pivot pin.

6. The recline boat seat of claim 5 wherein the slot is generally linearly aligned with the stop pin.

7. A recline boat seat hinge comprising: a back portion having a pivot axle, and a seat support portion having a through hole and a stop pin, the back portion having a plurality of stop shoulders so that when the pivot axle extends through the hole, the back portion may be rotated to multiple angles wherein each stop shoulder may abut the stop pin and angularly position the back portion to allow the user to adjust the seat back position manually.

8. The recline seat hinge of claim 7 wherein the back portion has at least three engagement positions relative to the seat support portion, a first folded position, a second recline position, and a third recline position.

9. The recline boat seat hinge of claim 7 wherein the plurality of stop shoulder comprises two notches corresponding to a first and a second recline position.

10. The recline boat seat hinge of claim 7 wherein the seat support portion is formed from a flat piece of metal and bent to form a flange.

11. The recline boat seat hinge of claim 7 wherein the back portion is formed from a flat piece of metal and bent to form a flange.

12. The recline boat seat hinge of claim 7 wherein the through hole includes a slot that is a linear elongated slot configured to allow linear movement of the pivot axle.

13. The recline boat seat of claim 12 wherein the slot is generally linearly aligned with the stop pin.
